(19) United States
(12) Patent Application Publication
(10) Pub. No.: US 2014/0172452 A1
(43) Pub. Date: Jun. 19, 2014

(54) SYSTEM FOR PROCESSING MEDICAL DATA

(71) Applicant: ADVANCED MEDICAL IMAGING DEVELOPMENT S.R.L., (US)

(72) Inventors: Giovanni TONTI, Sulmona (IT); Gianni PEDRIZZETTI, Prato (IT); Alberto ACQUAFRESCA, Vaiano (IT)

(73) Assignee: ADVANCED MEDICAL IMAGING DEVELOPMENT S.R.L., Sulmona (IT)

(21) Appl. No.: 13/715,228

(22) Filed: Dec. 14, 2012

(51) Int. Cl. G06F 19/00

(52) U.S. Cl. CPC G06F 19/321
USPC 705/3

(57) ABSTRACT

A system for processing medical data including: a central unit in communication with a storage of medical data, such central unit being controllable by at least a user of the system and at least one client unit, remote from the central unit, for communicatively coupling to the central unit and/or storage through at least a network, such client unit having an interface for allowing a user to interact with the system. Where the central unit is configured for remotely processing data of the storage, or causing the data to be processed by a dedicated elaboration unit coupled to such central unit and/or the storage, according to requests generated by the client unit and sending data to the client unit, and where the client unit is configured to locally interact with the data sent by the central unit to provide further requests to the central unit to iteratively process data of the storage according to user needs.

### TECHNICAL FIELD

The present invention relates to a system for processing medical data, particularly medical images in distributed cloud environments.

### BRIEF DISCUSSION OF RELATED ART

Nowadays most of the medical diagnostic processes employ medical imaging technology. Medical imaging gave a tremendous burst to the ability to improve diagnosis, and to devise adequate therapeutic solutions; where medical imaging is a term comprising several technologies, including Echography, MR, CT, radiography, angiography etc. The same term is used to indicate individual images, running clips made of several (even hundreds) images in sequence, or three-dimensional volumetric acquisitions, or, lately, even sequence of three-dimensional volumetric acquisitions (so-called 4D imaging, like the 3D recording of beating heart).

Medical imaging technology was originally developed with the purpose to “visualize” anatomical “structures” inside the body. During the technological development, printed images have been progressively substituted by digital formats that are visualized and stored in computer-driven digital devices.

Medical images are commonly stored in the DICOM (Digital Imaging and COmmunication in Medicine) format, which is a standard set of rules to encode image data from any different modality and accompany images with additional medical information that are integrative, from ECG, pressure curves, to type of exam, equipment employed, to identification codes. The DICOM format contains individual images, playing sequences or clips, sequences that compose 3D volumetric information, or sequences of 3D volumetric info, as well as fusion imaging obtained by combination of multimodality.

Every set of acquired medical images is composed by one or several DICOM files that pertain to an individual exam. That set is temporarily available on the recording equipment, or attached workstation, and it is then archived on a storage system. Storage is mandatory for some clinical fields in several countries and it is becoming common habit for good healthcare. Systems for the storage of medical imaging often goes under the name of Picture Archiving Communication System (PACS) that includes the possibility of image retrieval for later visualization or analysis.

The availability of digital images permitted to develop processing tools that go beyond the simple visualization and are capable to “analyze” the images and extract quantitative information about the “function” of the target organs inside the body. As an evidence, medical literature has been reporting a rapidly growing number of imaging-based studies, and most famous editors have introduced new imaging-dedicated journals (for example, in cardiology, Circulation, JACC and Eur. Heart J. have developed a Cardiovascular Imaging journal dedicated to studies based on imaging).

Analysis of medical images and extraction of additional quantitative information involve software applications that load the imaging data and process them. Numerous methods are available, from tracking objects in time, to evaluating the spatial distribution and/or time change of brightness, or space-time distribution of colors etc. All these go well beyond what can be evaluated from simple visual inspection, and have provided deeper diagnostic abilities and improvement to early diagnosis ability and following treatments.

Processing is typically performed on the imaging equipment (the echograph, the MRI equipment . . . ), or on powerful workstation closely connected to the equipment. The crucial points are that:

(1) the equipment must have a direct access to the imaging data whose size can be of several Gigabytes, and growing with improving technologies, and cannot be used remotely for real time manipulation; and
(2) the advanced software tools must be available locally on the dedicated workstation or on the equipment, tools that are continuously improving.

Diagnosis based on advanced processing of medical imaging information cannot be performed remotely from where acquisition has been produced. Such a remote analysis is potentially possible through unpractical procedures. Like that of transferring the Gigabytes of information to another location where the processing tools were previously installed and are locally available.

This practice poses several limitations. The medical doctor can hardly work in places different from the laboratory, like home or in a second structure. An expert cannot be consulted if not available physically, such an expert is rarely available in small medical centers or in specific periods. Second opinions are difficult to get. Revisions of previous results, for example after follow-up or in presence of complications, are possible only in the same center where the previous image acquisition was performed. Numerous other examples can be drawn.

In a wider perspective, the locality character for advanced analysis of medical imaging does not permit the development of rich data-bases containing synthesis of quantitative information as could be built by analysis of information that are distributed over the many medical centers. This type of synthesis would be a valuable support for the improvement of health care.

This is all the more true in view of the fact that in last years the storage has begun to be transferred onto distributed systems connected to the internet in consequence of an offer of massive storage managed by third party dedicated to this activity. This approach, going under the name of Cloud Storage and Cloud Computing, permitted to reduce costs of local hardware and its management and improved the reliability of data storage. Several solutions have been proposed for efficient storage and retrieval (PACS) functionality, and several cloud storage solutions available on the market (just digit, for example, “web pacs dicom” or similar on Google). In the totality of the cases the focus is on the storage and on the “visualization” of the images while advanced post processing is not considered. Remote image rendering is suggested in different contexts to reduce the local equipment software by moving some standard computational effort from the local equipment to remote servers as disclosed for example in U.S. Pat. No. 6,621,918. However images are still visualized only, although various options for best visual rendering are available, nevertheless interactive image processing for quantitative information extraction is not considered. This is mainly due to security reasons and processing limitations required in networking through openly-available internet connections. The existing technology for showing playing movies in “streaming” does not allow, in fact, close interaction between user and shown data other than visualization option like zoom, sections definition, 3D rotations that can be requested in real time. Moreover, remote working environment are typically “closed” and do not adapt to mutable and examination case dependent working condition and user needs.

Hence in all known solutions advanced post-processing requiring access and manipulation of the full data set is possible only by downloading the images of interest and by processing them locally with the desired tool. However, this replica of the method used with local storage would be an extremely not-efficient solution: time-consuming, not-real-time and requiring local availability of advanced equipment and processing tools.

### BRIEF SUMMARY

Provided herein is a system for real-time advanced processing of medical images in distributed cloud environments solving, at least partially, the above drawbacks.

The invention provides a system for processing medical data comprising:
a central unit in communication, or that can be placed in communication, with a storage of medical data, such central unit being controllable by at least a user of the system;
at least one client unit, remote from the central unit, for communicatively coupling to said central unit and/or storage through at least a network, such client unit having an interface for allowing a user to interact with the system.

The central unit is configured for remotely processing data of the storage, or causing the data to be processed by a dedicated elaboration unit coupled to such central unit and/or the storage, according to requests generated by the client unit and sending data to the client unit. The client unit is configured to locally interact with the data sent by the central unit to provide further requests to the central unit to iteratively process data of the storage according to user needs.

As the storage may be a distributed repository of medical data which can be located worldwide, the idea at the base of the invention is to perform the processing directly on the cloud system avoiding transfer of image data to the local client and the need of local availability of processing tools. The whole computational power is on the cloud system; the client (the medical operator, for example) is made of a basic technology allowing internet connection only. It can be made of a browser running on a personal computer or whatever workstation; it can be a tablet, a smartphone or another device connected to the internet, and the connection can be achieved through a browser or by a simple application (APP) that permits communication.

According to an embodiment, the central unit is configured to send, separately and/or together with data, instructions/applications to the client unit to allow the local interaction with the data. The client unit may be configured to at least partially use the instructions/applications sent by the central unit to interact with the data, choosing interactively operations that a user wants to perform on data and multimedia objects to visualize.

In this solution the local system has not to be dedicated and it is supposed to be available in most environments, while all the processing tools are installed and available on the cloud system. This approach permits to use standardized tools, analyses performed by different places or different operators with the identical tools, and also to have immediate availability and easy diffusion of the most advanced tools. Such tools are installed and available on the cloud system either on the central unit or in a dedicated elaboration unit. They can also be distributed in the cloud, for example in remote units. In this case, it is the elaboration unit or the central unit that requests remote processing or asks for instructions/applications/code from the remote units to provide such processing.

In any case, the processing is performed remotely with reference to the client units which can thus be very simple devices. To such extent the data sent by the central unit are preferably intermediate data having a reduced informative content aimed at allowing the user interaction. The final outcome of the processing is typically quantitative information extracted from medical images or videos and stored in the storage or in the central unit or in a memory associated thereto for subsequent download by the client unit. This allows to provide advanced processing of huge medical data even without having to download the final result of such processing that can be placed in the cloud along with all other types of medical data for subsequent access by every authorized user. This is particularly advantageous in systems for managing and displaying medical data as the one disclosed in US patent application published with number 2012/0046972.

According to an embodiment, the system comprises an elaboration unit, separated from the central unit, configured for interacting with data of the storage and producing images, videos and numerical data according to central unit and/or client unit requests. Central unit, according to client requests, schedules elaboration to the elaboration unit that are sent back to the central unit itself in order to prepare new instruction for the client to manage this new data. Elaboration unit results can also be directly forwarded to clients and directly managed by them.

According to an improvement, the client unit performs direct interactions both with the central unit and the elaboration unit, in protected sessions if needed; in such case, a further code layer on the client must be realized in order to manage the augmented communication complexity.

The storage is typically part of a PACS having connecting means for transferring healthcare information documents produced by one or more imaging modalities, particularly a Web-based PACS. In this case the central unit can be one of the interfaces for allowing Web access to the healthcare information documents generated by the imaging modalities and stored in the storage.

The processing of sensible data are advantageously performed in one or more protected dedicated areas of the system, there being provided security and data management means for preventing an authorized user from gaining access to said data. Any kind of security means can used for the purpose. For example those commonly used in PACS systems as far as access control, confidentiality, data integrity are concerned. For detailed technical descriptions on data security, reference may be made to the International Organization for Standardization (ISO) security architecture defined in section 5 of ISO/IEC 7498-2.

According to a preferred embodiment the interaction between the central unit and the client unit is in the form of web-server/web-client, the client unit executing portions of codes for accessing data from the central unit and/or the storage through a web browser. Such portions of codes are typically streamed in the html pages containing the data sent by the central unit to allow the client unit to interact with such data and prepare elaboration requests for the central unit. They can be equally rendered available on web sites dedicated for the purpose. In this case what is streamed is the address of such web sites.

The streamed code may be present on the central unit and ready for being sent to the client unit or it is prepared on-the-fly by the central unit as a function of the particular elaboration request made by the client unit.

According to an improvement, when a dedicated elaboration unit is present in the system, the central unit is configured to send the code to the client unit before the processed data is available so that the client browser can already visualize a page which contains all the controls and resources that will be used once the processed data is available. The web pages of the central unit typically carry Html and Javascript code that allows the user to interact with the processed data.

Quantification tools can remotely process the original data to obtain a statistical result, such statistical result being available to the users in place of the original data or along with the original data to improve knowledge, for example for setting up a database of known cases that could be consulted world-wide or a database containing synthesis of quantitative information as could be built by analysis of information that are distributed over the many medical centers.

According to an aspect, the client unit, the central unit and the elaboration units are configured to perform the following steps:
the client unit sends from a user, via the graphics user interface of a browser, a request for an elaboration to be performed;
central unit forwards the request to the elaboration unit and, in the meantime, sends back to client unit a new html page that contains new layout and the code that will be able to manage the produced data when available;
the elaboration unit accesses related files, typically DICOM files, in the storage and starts elaboration;
when elaboration unit finishes its job, it stores elaborated data into a space reachable by the central unit;
elaboration unit signals to the central unit that elaboration is fished and that data are ready;
browser of the client unit periodically polls for elaboration completion;
central unit sends data and tunneled addresses to access the elaborated data;
the browser manages data with proper Graphics User Interface interaction.

### BRIEF DESCRIPTION OF THE DRAWINGS

The characteristics of the invention and the advantages derived therefrom will be more apparent from the following description of non-limiting embodiments, illustrated in the annexed drawings, in which:

FIG. 1 shows a simplified block diagram of a cloud computing environment including a system according to the invention.

FIG. 2 schematically shows how the client unit of FIG. 1 interacts with the central unit in an embodiment where a dedicate elaboration unit is present.

### DETAILED DESCRIPTION

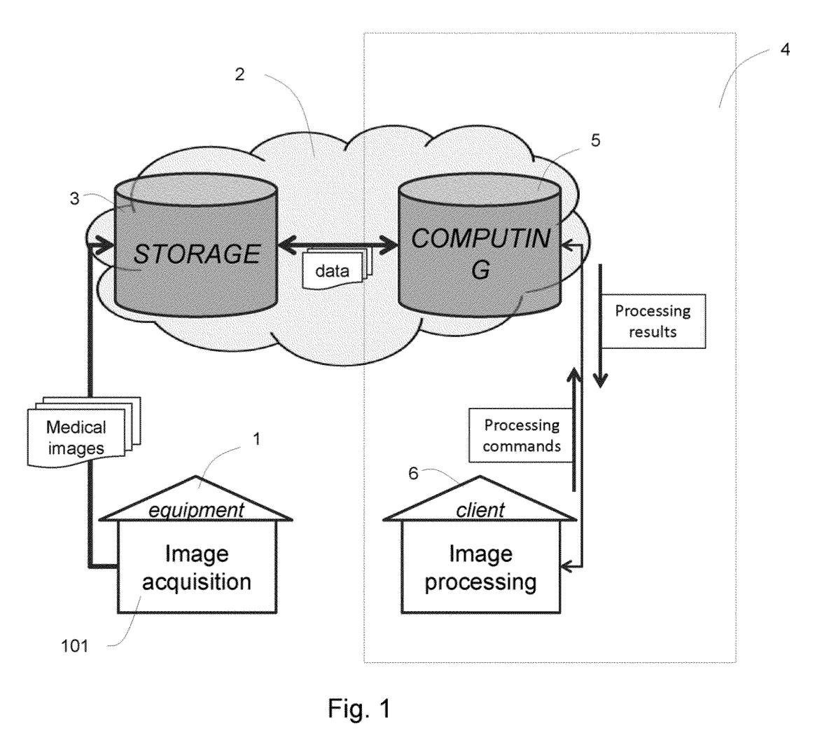

FIG. 1 shows a typical flux of information in a system for managing medical data. The massive medical data acquired with the imaging equipment 1 is stored in the cloud 2 according to any known method as disclosed, for example, in US patent application published with number 2012/0046972 which is to be considered herein incorporated by reference. To take advantage of a distributed cloud environment, the storage 3 and the medical equipment performing image acquisition 101 (only one in the figure, but obviously a plurality of medical equipment in a more realistic situation) are preferably interconnected through the Internet in the form of a so-called Web-based PACS. It is however to be noted that the present invention is not to be considered limited to such applications as it can be advantageous in any environment where a storage of medical data is present whichever is the means for updating such storage, the location of the same and the technical means of communications used.

The system of the invention, which is sketched enclosed in a dotted box 4 in FIG. 1, is interfaced with the storage 3 to allow a central unit 5 to retrieve data from the storage to perform advanced processing. The central unit 5 can also have write access to the storage 3 to save the result of such processing thus enriching its informative content that can be shared in the cloud. This is particularly important for increasing human knowledge, for example for setting up a database of known cases that could be consulted world-wide or a database containing synthesis of quantitative information as could be built by analysis of information that are distributed over the many medical centers. This type of synthesis would be a valuable support for the improvement of health care.

It's not necessary that the communication of the storage 3 with the central unit 5 is fixed as it can be activated on request. Of course, in a more streamlined solution, the storage 3 is part of a PACS as well as the central unit 5.

User interaction with images, videos and data is achieved through a remote client unit 6 connected to the central unit 5. Through the client 6, data are visualized and elaboration requests are performed. Due to security reasons and bandwidth limitation, elaborations on sensible data are performed into one or more protected dedicated areas in the cloud system.

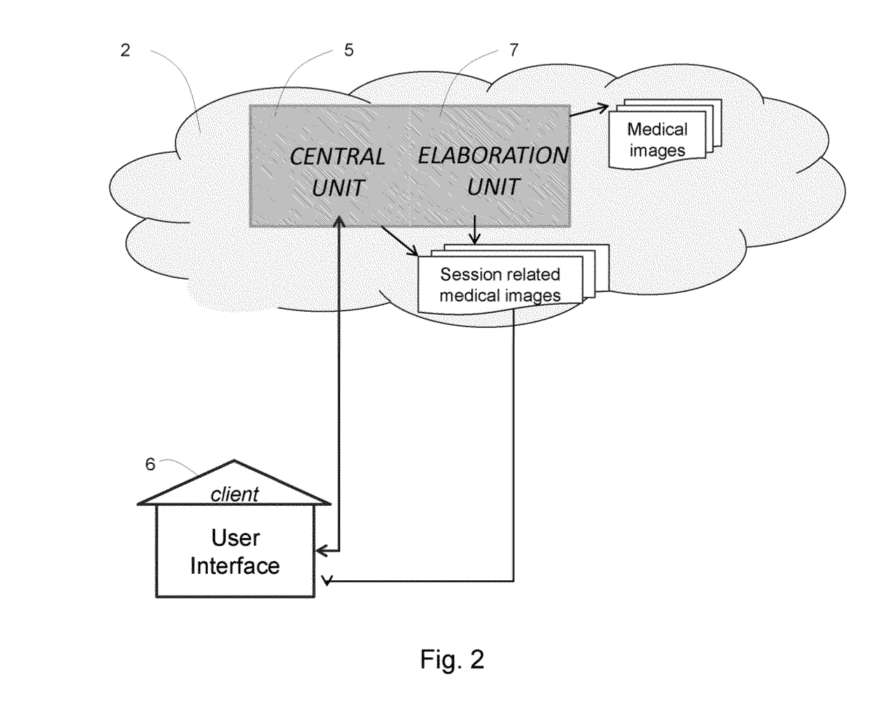

As shown in FIG. 2, the central unit 5 is or preferably operates in conjunction with an elaboration unit 7. Multimedia and numerical data sets can be produced from scratch by elaboration unit 7 according to the request that can be generated by user interaction on client 6. For example, user can trace a line on a frame of a B-Mode representing video, and elaboration unit can generate a M-Mode plot according to the requested line, to be sent back to client and visualized. These produced data must be available to clients for the current session and are placed in an accessible area.

Central unit 5 sends clients 6 images, videos and instructions about managing GUI (Graphical User Interface) in order to interact with them and to send back to the central unit 5 the feedback of user interaction on data and images. Starting from this interaction, new images, videos, numerical data, and instruction can be generated from central and elaboration units and reproduced on the client 6. Central unit 5 may produce directly the necessary images, videos and numerical data or may delegate their production, partly or completely, to the elaboration unit 7 that sends back produced material, raw or in file format, to the central unit 5 before new instructions are posted back to client. Data can be produced asynchronously from elaboration unit 7; in such cases, they can be posted to clients in different sessions and client will update its user interface more times.

High valued synthetic information (such as the dimension of a lesion or the energy dissipated by a cardiac valve) or processed images and videos can so be carried out through an iterative elaboration workflow, starting from acquired images, videos and DICOM data, producing new images, videos and numerical data that can be used as bases to produce further images, videos and numerical data. The iterations of such a process are driven by user through its interaction with the client 6 and the visualization of elaborated information, and they depend on the single medical case taken into account. At the end of this process, synthetic data can be manually extracted from graphical user interface (for example with drag and drop operations directly on final documents) or inserted in automatically generated documents (such as pdf, doc or rtf) or stored on remote storage 3 for future uses. Produced videos and images can be directly downloaded or stored in storage as well. Huge DICOM data are never moved to the client: all elaborations and image and video generated are realized in a server side area. This permits to focus the development efforts in medical imaging equipment for optimization of the acquisition process for best imaging, not to the post-processing software that instead will reside on a separate technology.

Clients 6 can be realized by means of web browser or stand-alone applications. When a web browser is used as client, the GUI generation instructions may be directly sent by the central unit 5 in the form of code or binaries compatible with browser standard technologies. If custom applications are used as clients, instead, such instructions may represent a more general description of GUI in a proprietary protocol, and they may be pulled through a web services based software architecture or by remote database connections.

A possible embodiment of the invention is in the form of a storage, web-server and web-client browser interaction. Web servers interact with a local storage or a cloud storage DICOM data set and fill code stream (for example, but not limited to, in html, Javascript, html5) that are run on web browser. These code streams contain instructions on about how to operate user live interaction with them; provides information on about how to render images, to play videos, to perform interactions on images and videos (such as lines or areas drawing and sections definitions) and to set parameters for the production of new data set to be visualized (such as numerical parameters for algorithms on central/elaboration unit or color maps selections). According to user requests, new code streams are then generated by the central unit and sent to the client. The central unit 5 takes care also to guarantee the availability of needed DICOM set from storage 3 and of the produced multimedia objects and numerical data produced by the central unit 5 itself or by the elaboration unit 7, when processing requests from client 6. Stub interfaces and components may exist between elaboration unit 7, cloud storage 3 and web server 5 due to security, permission and bandwidth reasons. In this embodiment, all sensible data are furnished through a central server data protected channel; stored or produced multimedia data files can be accessed through the central unit to be furnished to clients, when their domain is not directly accessible from clients or when they can be accessed, but not be manipulated for security reasons (as in the case of video to be directly manipulated by code on clients).

When a client 6 requires an elaboration to be performed, numerical data can be produced as well as complex and structured data. These data can be visualized and interacted with trough a GUI (graphical user interface) in order to request further elaborations that the server is able to perform. Client 6 could not be able to allow the user to interact effectively with all the produced data and could not fully know all the processing functionalities that the server could further perform on them. The injection of pieces of code capable of treat complex data can be so streamed from server when needed.

In a web-server/web-browser representation of the system, these functionalities could be thought as pieces of code, written in a standard language like Javascript just for example or another, directly embedded (streamed) into the html of the loaded page, or linked code for an embedded client (like Flash or Silverlight). These pieces of code could be previously existing on the central unit or could be prepared at each elaboration request and made available together with the elaborated data or just before, embedded or linked in a response html page. Several code routines could be tailored on generated data; for example they could contain adapted color maps or spatial visualization filters to be used by rendering routines. Several local processing elaborations could be directly operated on the client by this code, like linear or sectorial angle measurements.

The code stream architecture offers a way to continuously update central unit capability without updating any client installation.

As an example, we can think to a situation in which a user is interacting with a web-browser (client) showing a left ventricle image. A continuous track can be drawn on the border of the ventricle, and a volume evaluation elaboration is asked to the server. The remote elaboration unit produces a numerical data (the required volume in ml) and a 3D volumetric representation of the ventricle cavity. If the client could manage this point set, user could rotate, zoom, and navigate on the surface. The client should be able to reproduce further computational results (velocity map, deformation, activation map) to be represented on the 3D surface and to change visualization modalities and parameters. Code to visualize and interact with these produced data can be generated on the fly or statically linked to a response html page at each client request.

This can be realized in various methods. In one embodiment, for example, a central unit (a Web Server) sends to the browser html and Javascript code in order to visualize and interact with images and videos. User can interact on images and videos and can ask for elaboration on particular ROIs (regions of interest). The browser sends the request to central unit that performs directly all elaboration steps before generating a new response page. In the new page, all numerical data and generated multimedia resources are directly linked or inserted. The html page carries a new html/Javascript code that is able to interact with the processed data. This code may be generated on the fly by central unit and “streamed” directly in the new html page directly, or linked in the server address space.

Another embodiment, more reliable on time consuming elaborations, takes advantage of a dedicated elaboration unit. The browser sends elaboration requests to the central unit and processing is performed by the elaboration unit, that accesses stored information (image and related files), and elaborates them. While the elaboration is being performed, the central unit sends to the browser a new page that can be incomplete: it may not yet carry the final elaborated data information but can perform some functionalities (can play other video, navigate thorough patient data, etc) and already contains the code that will be used to manage the produced data, when will be available. The browser will so poll central unit remote services until elaboration completion and when the elaboration is finally finished, produced new multimedia resources are downloaded and numerical data are accessed. The elaboration can produce videos, images and numerical data to be rendered or visualized. The elaborated multimedia resource itself can be accessed directly by the browser if the connection is available, but for security reason it may be not fully or partially reachable (for example, in html5 videos reachable in different ip domain are not accessible in their inner pixel content but only playable as a whole). So, elaboration unit when finishes its work may fill a database entry or notify directly the central unit, and place multimedia results in a space accessible by central unit. The central unit can tunnel the multimedia resource and the browser will access the resource using the same ip address domain that the one of the loaded page.

Another exemplary embodiment can be particularly appropriate when longer or multiple elaborations are involved (batch operations). After each elaboration request, clients do not wait any answer from central unit, but come back to a base page, that the server furnishes according to currently available data. The page can be refreshed with proper user request (acting on GUI) or refreshed automatically by server when new elaborated data are generated by elaboration unit and signaled to the server.

Although the system according to the invention has been mainly described with reference to a Web Server/Web Client interaction which certainly represents the most straightforward solution, this is not to be considered a limiting feature. It can, in fact, be appreciated that clients can be realized both as web browser pages or as stand-alone applications. Pieces of code in term of script files or proprietary language interface definition and managing sequences could be sent by the central unit using any kind of protocol as long as a proper interpretation engine is present on the client side, all without departing from the guiding principle of the invention.

1. System for processing medical data comprising:
a central unit in communication, or that can be placed in communication, with a storage of medical data, such central unit being controllable by at least a user of the system;
at least one client unit, remote from the central unit, for communicatively coupling to said central unit and/or storage through at least a network, such client unit having an interface for allowing a user to interact with the system,
wherein the central unit is configured for remotely processing data of the storage, or causing the data to be processed by a dedicated elaboration unit coupled to such central unit and/or the storage, according to requests generated by the client unit and sending data to the client unit, and
wherein the client unit is configured to locally interact with the data sent by the central unit to provide further requests to the central unit to iteratively process data of the storage according to user needs.

2. System according to claim 1, wherein the central unit is configured to send, separately and/or together with data, instructions/applications to the client unit to allow such local interaction with the data.

3. System according to claim 2, wherein the client unit is configured to at least partially use the instructions/applications sent by the central unit to interact with the data, choosing interactively operations that a user wants to perform on data and multimedia objects to visualize.

4. System according to claim 1, wherein the data sent by the central unit are intermediate data having a reduced informative content aimed at allowing the user interaction, the final outcome of the processing being an elaborated data stored in the storage or in the central unit or in a memory associated thereto for subsequent download by the client unit.

5. System according to claim 4, wherein the final elaborated data is quantitative information extracted from medical images or videos held in the storage.

6. System according to claim 1, further comprising an elaboration unit, separated from the central unit, configured for interacting with data of the storage and producing images, videos and numerical data according to central unit and/or client unit requests.

7. System according to claim 6, wherein the elaboration unit is configured to perform processing asynchronously and notify the central unit when such processing is terminated.

8. System according to claim 7, wherein the elaboration unit is configured to place the processed data in the storage or in a space reachable by the central unit that can be tunneled to the client unit.

9. System according to claim 1, wherein the storage is a distributed repository of medical data.

10. System according to claim 1, wherein the storage is part of a PACS having connecting means for transferring healthcare information documents produced by one or more imaging modalities.

11. System according to claim 10, wherein the PACS is a Web-based PACS, the central unit being one of the interfaces for allowing Web access to the healthcare information documents generated by the imaging modalities and stored in the storage.

12. System according to claim 1, wherein the processing of sensible data are performed in one or more protected dedicated areas of the system, there being provided security and data management means for preventing an authorized user from gaining access to said data.

13. System according to claim 1, wherein the interaction between the central unit and the client unit is in the form of web-server/web-client, the client unit executing portions of codes for accessing data from the central unit and/or the storage through a web browser.

14. System according to claim 13, wherein such portions of codes are streamed in the html pages containing the data sent by the central unit to allow the client unit to interact with such data and prepare elaboration requests for the central unit.

15. System according to claim 13, wherein the streamed code is present on the central unit and ready for being sent to the client unit or it is prepared on-the-fly by the central unit as a function of the particular elaboration request made by the client unit.

16. System according to any claim 13, wherein, when a dedicated elaboration unit is present in the system, the central unit is configured to send the code to the client unit before the processed data is available so that the client browser can already visualize a page which contains all the controls and resources that will be used once the processed data is available.

17. System according to claim 13, wherein the web pages of the central unit carry Html and Javascript code that allows the user to interact with the processed data.

18. System according to claim 1, wherein quantification tools remotely process the original data to obtain a statistical result, such statistical result being available to the users in place of the original data or along with the original data.

19. System according to claim 1, wherein the client unit, the central unit and the elaboration units are configured to perform the following steps:
the client unit receives from a user, via the graphics user interface of a browser, a request for an elaboration to be performed;
central unit forwards the request to the elaboration unit and, in the meantime, sends back to client unit a new html page that contains new layout and the code that will be able to manage the produced data when available;
the elaboration unit accesses related files, typically DICOM files, in the storage and starts elaboration;
when elaboration unit finishes its job, it stores elaborated data into a space reachable by the central unit;
elaboration unit signals to the central unit that elaboration is fished and that data are ready;
browser of the client unit periodically polls for elaboration completion;
central unit sends data and tunneled addresses to access the elaborated data;
the browser manages data with proper Graphics User Interface interaction.
